(19) United States
(12) Patent Application Publication
(10) Pub. No.: US 2014/0095329 A1
(43) Pub. Date: Apr. 3, 2014

(54) OPEN CANVAS ADVERTISING UNIT

(71) Applicant: Yahoo! Inc., (US)

(72) Inventors: Agnes Liu, Walnut, CA (US); Bonnie Pan, San Francisco, CA (US); Chialing Hsu Sarva, New York, NY (US); Guy Schackman, Santa Monica, CA (US)

(21) Appl. No.: 13/830,551

(22) Filed: Mar. 14, 2013

Related U.S. Application Data
(60) Provisional application No. 61/707,812, filed on Sep. 28, 2012.

(51) Int. Cl. G06Q 30/02

(52) U.S. Cl. CPC G06Q 30/0277
USPC 705/14.73

(57) ABSTRACT

A full screen advertisement is embedded within the content of a webpage that comprises a plurality of portions that are configured to form fit the display so that each portion of the webpage extends between the four edges of the display. The advertisement is also response as it reshapes to form fit the resolution of the output device. The advertisement also includes a gated content section that can be unlocked through a product purchase or through a social tie-in.

### CROSS REFERENCES TO RELATED APPLICATIONS

This application claims priority to U.S. provisional application Ser. No. 61/707,812 filed Sep. 28, 2012 having title “Interactive Reveal Ad Unit”. The entirety of which is incorporated herein by reference.

The present disclosure relates to a full screen advertisement within a webpage of stacked modules.

### BACKGROUND

Many online services currently exist which bring information and entertainment to users wherever they may be located via various modalities. Content providers can employ communication networks to provide passive content such as books, music, videos such as movies or they may provide more interactive content such as video games or social networking activities. Some of these services collect fee from the users while other services are provided free of cost. Generally such free services are sponsored by advertisers who pay the content providers in order to have the users view a short commercial video or an image associated with a product or service they may be advertising. The advertisements included in the webpages are designed to attract users' attention with their size or by including catchy phrases, graphics, animations or restricting the user from navigating the webpage unless they interact with the advertisement.

### SUMMARY

This disclosure facilitates creating a full screen advertisement that is stacked between modules or potions of a webpage so that it does not interfere with the users' browsing experience and yet provides a large canvas to advertisers to deliver their message.

A processor-executable method for providing a full screen advertisement on a webpage without hindering the users' browsing experience is disclosed in an embodiment. The method comprises receiving, by the processor, a request for a webpage from a device comprising a display screen. The webpage is partitioned horizontally into a plurality of portions arranged one below another, each portion of the plurality of portions is configured to form-fit the display screen is retrieved by the processor. The processor also configures at least one of the plurality of portions as an advertising portion or advertising portion such that an advertisement within the advertising portion form fits the display screen. The webpage comprising the advertising portion is then transmitted to the device. In an embodiment, each of the plurality of portions is configured to form-fit a display screen of the device such that each portion extends between a first set of opposite edges and a second set of opposite edges that delimit the display screen. The processor facilitates such form-fit by transmitting with the webpage, code that determines dimensions of the display screen and code to size each of the plurality of portions and arrange content therein based on the determined dimensions.

In an embodiment, a link to an advertising server is included, by the processor, within the advertising portion. In an embodiment, the advertising portion is also configured to comprise a gated content portion that facilitates providing additional content. A code for unlocking the additional content is provided to the user via different modalities which can include, product purchases or social tie-ins. The code for unlocking the additional content in the gated content portion is received by the processor which verifies the code and transmits the additional content upon the verification. In an embodiment, the processor configures the gated content portion for prompting a user to visit a second webpage disparate from the initially transmitted webpage to obtain the code.

In an embodiment, the advertisement is further configured, by the processor to be responsive so that it form-fits the display screen upon a reorientation of the device from an original position to a new position. Code that detects orientation of the device and code that determines dimensions of the display screen when a change in orientation is detected is associated with the webpage in order to configure it to be responsive to changes in orientation of a device displaying the webpage. In an embodiment, content in the one of plurality of portions that is currently occupying the display screen is also rearranged upon the reorientation of the device so that the currently displayed portion form fits the display screen when the device is in the new position.

In an embodiment, two or more of the portions of the webpage may comprise advertisements. In further embodiments at least one content bearing portion of the plurality of portions is inserted between the two advertising portions. In an embodiment two links to two different advertisements can be inserted by the processor into the two portions.

A computer readable storage medium, comprising instructions, which when executed by a processor cause the processor to receive a request for a webpage from a device comprising a display, retrieve the webpage partitioned horizontally into a plurality of portions arranged one below another, each portion of the plurality of portions is configured to form-fit the display, configure at least one of the plurality of portions as an advertising portion such that an advertisement within the advertising portion form fits the display and transmit the webpage comprising the advertising portion to the device. Instructions for configuring each of the portions to form-fit the display further comprise instructions for transmitting with the webpage, code that determines dimensions of the display and code to size each of the plurality of portions and arrange content therein based on the determined dimensions. In an embodiment, the advertising portion comprises a link to an advertisement from an advertising server. In an embodiment, a gated content portion that facilitates providing additional content is included within the advertising portion.

A computing device comprising a processor and a storage medium for tangibly storing thereon program logic for execution by the processor is disclosed in an embodiment. The program logic comprises, request receiving logic for receiving a request for a webpage from a device comprising a display, webpage retrieval logic for retrieving the webpage partitioned horizontally into a plurality of portions arranged one below another, each portion of the plurality of portions is configured to form-fit the display, configuring logic, for configuring at least one of the plurality of portions as an advertising portion such that an advertisement within the advertising portion form fits the display and transmitting logic for transmitting the webpage comprising the advertising portion to the device. In an embodiment, the advertising portion comprises a gated content section that provides additional content.

These and other embodiments/will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIGS. 1A, 1B, 1C and 1D are schematic diagrams of an embodiment of a multi-device website that includes a full screen advertisement module in accordance with an embodiment;

FIG. 2 is a schematic diagram showing a large canvas advertisement that is designed to be included in the advertising portion in accordance with an embodiment;

FIG. 3 is a schematic diagram showing a large canvas ad with the auxiliary content that is displayed upon a user entering an unlock code in accordance with an embodiment;

FIGS. 4A and 4B illustrate transitional schematic diagrams that show a user navigating between different portions of the webpage by dragging the scrollbar;

FIG. 5A shows a schematic diagram of rearranged content in the advertisement in accordance with an embodiment;

FIG. 5B shows another schematic diagram of rearranged content in the advertisement in accordance with an embodiment;

FIG. 6 shows a flowchart detailing a method of serving a full screen advertisement within a webpage of stacked modules in accordance with an embodiment;

FIG. 7A shows a flowchart detailing a method of displaying a full screen advertisement without interrupting user browsing in accordance with an embodiment;

FIG. 7B shows a flowchart detailing a method of configuring modules or portions of a webpage flexibly to form-fit a display screen in accordance with an embodiment;

FIG. 8 shows a flowchart detailing a method of encouraging positive user interaction with an advertisement in accordance with an embodiment;

FIG. 9 illustrates a schematic diagram of a system for generating and displaying a multi-device website in accordance with embodiments described herein;

FIG. 10 illustrates internal architecture of a computing device in accordance with embodiments described herein;

FIG. 11 is a schematic diagram illustrating a client device implementation of a computing device in accordance with embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Users in the current era have a large selection of content sources to choose from for passive or interactive content. The users can either pay for the content or have the content sponsored by entities whose messages they may receive prior to or while accessing the content. In different scenarios the advertisements presented by the content sponsors usually appear as banner ads or small images at different locations of GUI. For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

Content providers occasionally allocate large space to sponsors, for example, as interstitials overlaid on top of content or takeovers that prevent users from navigating the webpage without closing or otherwise interacting with the advertisement. However, such advertisements intrude on users' browsing experience and may prevent users from engaging further with the website. Hence, content providers are constrained to displaying commercials or advertisements to small portions of a website which do not occupy any substantial screen space. Even when the advertisements do occupy substantial portions of the screen space, they can do so very briefly or buttons/links to close them are provided. This problem is further exacerbated in the era of mobile devices that have much smaller screens as compared to laptops or desktops and hence restrict the messages that advertisers can relay to the users.

Embodiments described herein provide for an open canvas advertisement module or portion that is stacked between other portions of the website so that it is seamlessly integrated with the other content of the website and does not intrude on a user's browsing experience. The large open canvas advertisement provides a larger screen real estate which allows the advertiser to build their own interactive experiences that can be integrated with a website as a whole. The open canvas ad creates a symbiotic relationship between the advertisement and content. Not only do the ads look and feel like a natural portion of the website but they enhance the overall content of the website. For example, in a website associated with a movie, the ad can provide bonus scenes from the movie or interviews with the cast and crew of the movie thereby resulting in greater user engagement with the website and the ad. This facilitates revenue generation opportunities for content providers while providing greater canvas to the content sponsors or advertisers to deliver their messages.

Some embodiments of the large canvas advertising unit are responsive so that the same code module can be used across multiple platforms and devices. For example, the advertisement module or advertisement portion of the webpage can reshape to form fit the resolution of the output device. Thus, an advertising module or portion of the webpage is displayed in an expanded format occupying greater space when displayed in a landscape orientation of a desktop or laptop screen while the same advertising module or portion collapses to rearrange content when displayed in a portrait orientation on the display screen of a mobile device, such as, a smartphone.

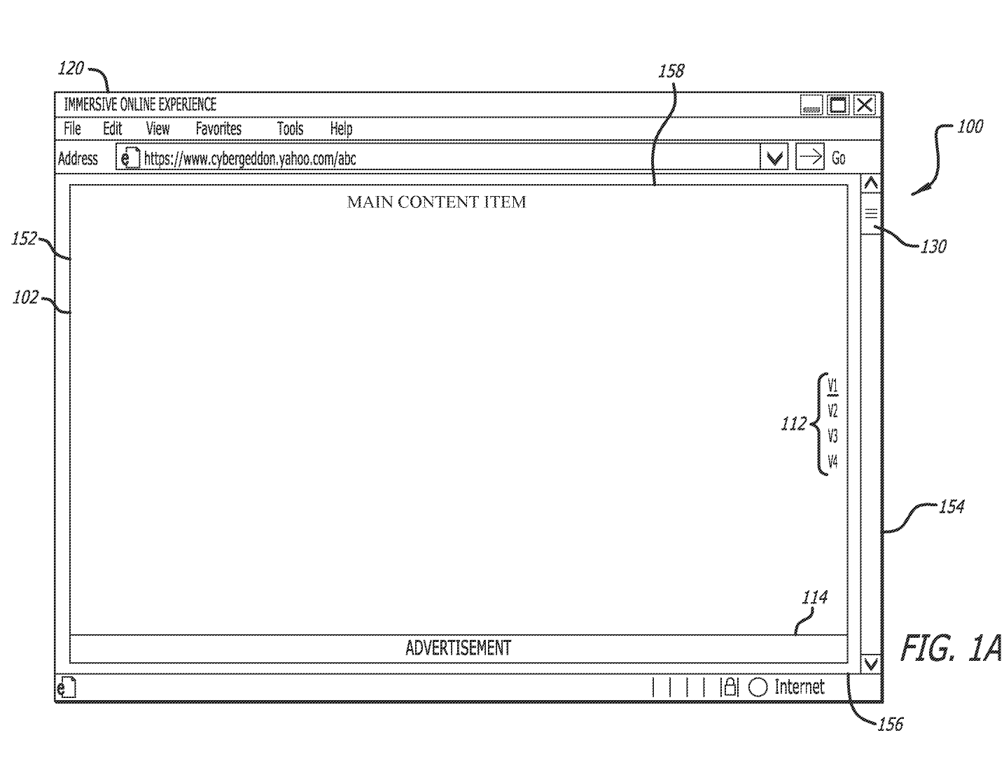

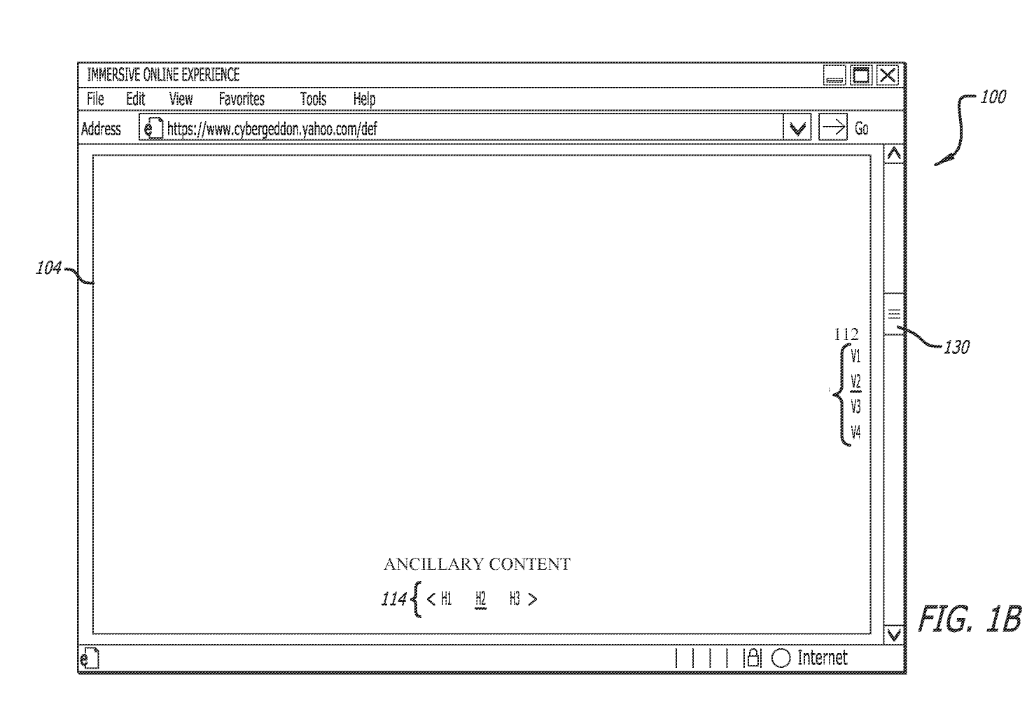

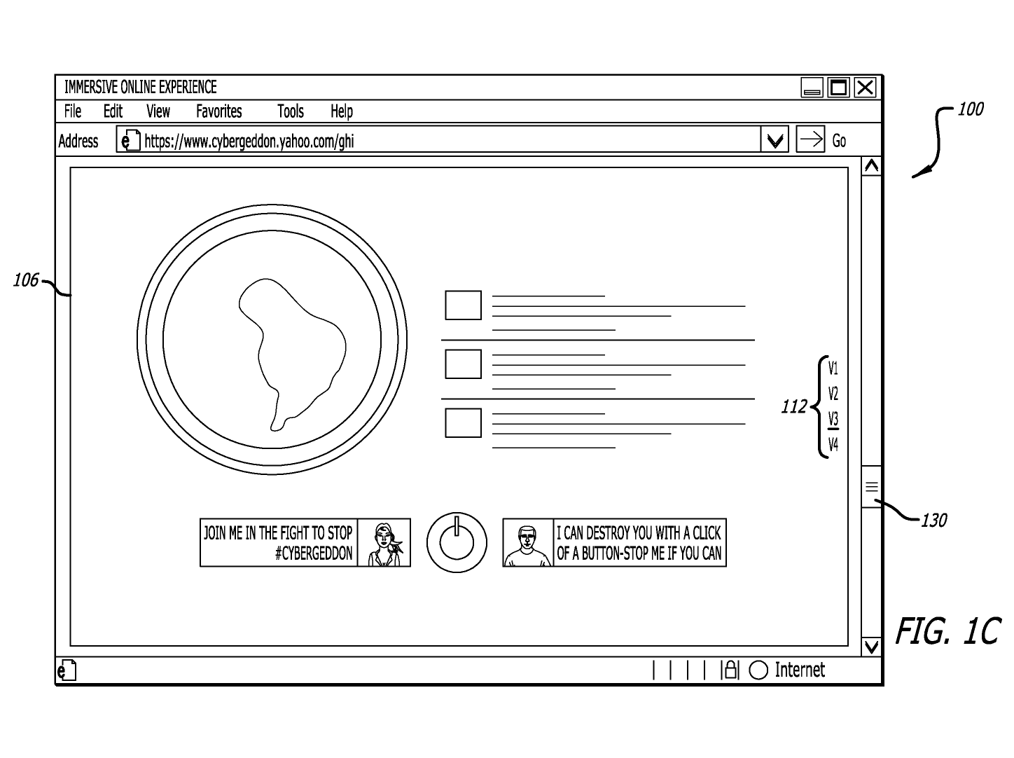

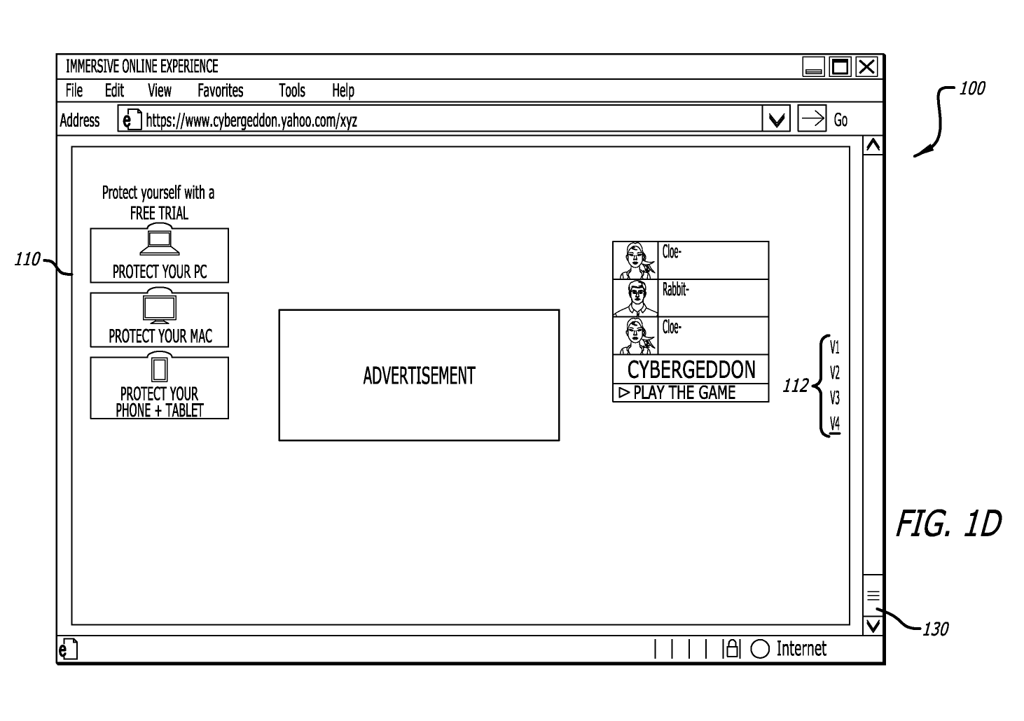

Turning now to the figures, FIGS. 1A, 1B, 1C and 1D are schematic diagrams of an embodiment of a multi-device website 100 that includes a full screen advertisement module 110 in accordance with an embodiment. In an embodiment, the website comprises content related to a single, central theme arranged in one long GUI (graphical user interface) accessible to users as a webpage upon navigation via the Internet or as a mobile application also accessible via other communication networks. In particular, different portions of a long webpage 100 as they are displayed on a display screen 120 of a computing device are illustrated. The webpage 100 is partitioned horizontally into a plurality of portions or display modules, 102, 104, 106 and 110 respectively shown in FIGS. 1A, 1B, 1C and 1D. It may be appreciated that four portions/modules are shown by the way of illustration and that the webpage 100 can comprise more or less modules. The plurality of portions 102, 104, 106, 110 are arranged consecutively one below the other to form the long webpage 100. The user can access each of the portions 102, 104, 106 and 110 either via a continuous scroll using the scroll bar 130 or by jumping between modules using access elements/links 112. Each of the portions 102, 104, 106 and 110 are sized and the content therein is arranged such that each portion is configured or designed to form fit the display screen 120. Alternately, each of the portions 102, 104, 106 and 110 is sized and the content therein is arranged to be displayed within the two sets of opposite edges 152, 154 and 156, 158 that delimit or form the perimeter of a display screen 120. In this embodiment, while continuous scrolling from one module to another is facilitated by the scrollbar 110, jumping from one portion to another using the links 112 will provide a view of the webpage 100 in conformance with its design. As seen in FIGS. 1A, 1B, 1C and 1D, the position of the scroll bar 130 is indicative of the portion of the webpage 100 that is currently being displayed. Similarly, one of the links 112 is highlighted or otherwise emphasized based on the portion currently being viewed. Again, it can be appreciated that a complete view of each of the portions 102-110 is facilitated regardless of whether the GUI 100 is accessed via the Internet as a webpage or via a mobile device such as a Smartphone or a tablet.

In an embodiment, each of the portions 102, 104, 106 and 110 is designed to include different content. It may be appreciated that the details of the content in the various portions is described below only by the way of illustration and that other content and/or arrangement of content can also be contemplated for inclusion in the website 100 in accordance with other embodiments. In one embodiment, one of portions 110 is an advertisement that displays a message related to an advertiser or an entity sponsoring the webpage 100. It may be appreciated that the advertisement portion 110 is shown at the bottom of the webpage 100 only by the way of illustration and that the advertisement portion 110 can be arranged at the top of the webpage 100 or inserted between other portions 102, 104, and 106 in accordance with certain embodiments.

The advertising portion 110 is included below the third portion 106 and can comprise an advertisement associated with a sponsor of the webpage 100 in an embodiment. The advertisement can be a large canvas advertisement embedded within a page of stacked portions and may occupy the entire display screen 120 of a computing device that receives and displays the webpage 100. The large canvas ad is designed to be integrated with the webpage 100 and adds to the overall user experience. This allows the advertisers to build their own interactive experiences that can be seamlessly integrated within a long page format. A large canvas ad that is custom designed for a particular webpage and thus stacked between other portions of the webpage 100 provides an opportunity to bridge what is often a big disconnect between advertising and content. Since the open canvas ad of the portion 110 fits in the long modular page 100 in the same manner as regular content modules/portions 102, 104 and 106, advertisers are incentivized to utilize the space in a manner that complements the overall theme of the webpage 100 thus providing a more immersive experience to the users.

In an embodiment, the content server that retrieves and serves the webpage 100 can include a link to an advertisement within the portion 110 so that a device receiving and displaying the webpage 100 can simultaneously retrieve the advertisement from a disparate advertising server (not shown) and display it along with the content in the webpage 100. In an embodiment, the content server and the advertising server can be hosted on the same machine so that the advertisement is included in the webpage 100 along with the content and transmitted for display to a device. In an embodiment, the advertiser can choose to provide additional content to users in the advertising portion 110. For example, the large canvas ad can be employed as a gated content section that can be unlocked through a social tie-in or a product purchase as will be described further herein. The gated content section encourages users to interact with the sponsor's products in order to find a key to unlock the content which in turn drives them deeper into the content of the webpage 100.

A brief description of content included in the other portions 102, 104 and 106 of the webpage 100 is given below by only by the way of illustration and not limitation to provide an overall context. It may be appreciated that features associated with one of the portions 102, 104, 106 or 110 can be incorporated into other portions according to some embodiments. In an embodiment, the first portion 102 is the initial landing view of the webpage 100 that is shown to a user who initially accesses the webpage 100. For example, if the central theme is a content item, the landing section or module 102 can include the main content item itself. In an embodiment, the portion 102 can be a title page comprising a trailer/preview of the content item which is comprised in one of the other portions 104 or 106 arranged below the portion 102. In addition to the content, the landing portion 102 can also include an advertisement 114. In an embodiment, the advertisement 114 can be an interactive reveal advertisement which moves gradually from the bottom/top of the webpage 100 to the middle of the display screen 120 and shows different images/content as the user scrolls down the webpage 100. In an embodiment, the access links 112 to other portions of the webpage 100 are included in the landing portion 102. One of the links, for example, V4 can be used to access the advertisement portion 110.

The second portion 104 is arranged below the landing portion 102 as indicated by the position of the scrollbar 110 and the highlighted link/navigation element 112. The second module 104 can comprise content which is ancillary to the main content item included in the module 102. In an embodiment, the ancillary content can be spread over multiple screens or a plurality of horizontal display modules or portions which are accessible via the links/horizontal navigation elements 114 each of which can correspond to one of the screen/horizontal display module. Therefore, by the way of illustration the information or ancillary content in the vertical display module 104 is further distributed over three horizontal display modules accessible by either clicking the symbols or by clicking the arrow. As seen in FIG. 1B the navigation element “H2” of the three horizontal navigation elements 114 is highlighted thereby conveying that the second screen or the second horizontal display module of the portion 104 is currently being displayed within the webpage 100. It can be appreciated that the screens/views of other portions 102, 106 and 110 or the URL of the webpage 100 do not change as a result of such horizontal navigation in the portion 104. For example, if the user scrolls upwards or jumps back to the first portion 102, the view/display/screen last shown to the user in module 102 will continue to be displayed even as the user navigates among different horizontal display modules within the portion 104. Therefore, the same view of the portion 102 is maintained as the user navigates among the three horizontal display modules in the vertical display module 104.

The third portion 106 is arranged below the second portion 104 as evident from the location of the scrollbar 130. In one embodiment, the third vertical display module 106 can include social networking content/interactivity tools associated with the main content item or theme around which the webpage 100 is designed. The social networking content can include messages released by the users to a shared messaging system or social networking games based on the main content item or theme.

In an embodiment, the same webpage 100 can be accessed by users regardless of the device being employed. Therefore, the same URL can be employed by users to via a desktop computer, a tablet or a smartphone. Additionally, the webpage 100 auto-resizes to adapt to the output screen resolution or device. Furthermore, the content in the webpage 100 can be re-arranged to suit the orientation of the display screen 120. For example, the content of the webpage 100 is initially displayed in a landscape orientation. However, when a display device/display screen 120 is re-oriented in a portrait orientation, the content can be rearranged and/or resized such that a user has the access to all the content of that particular view regardless of the orientation of the display screen 120. The user will therefore have access to the same content of a particular display in any orientation without having to zoom the content to a different size. In an embodiment, the content can be re-arranged and resized to form different views in landscape and portrait orientations so that the user is not subjected to undue discomfort while accessing the content.

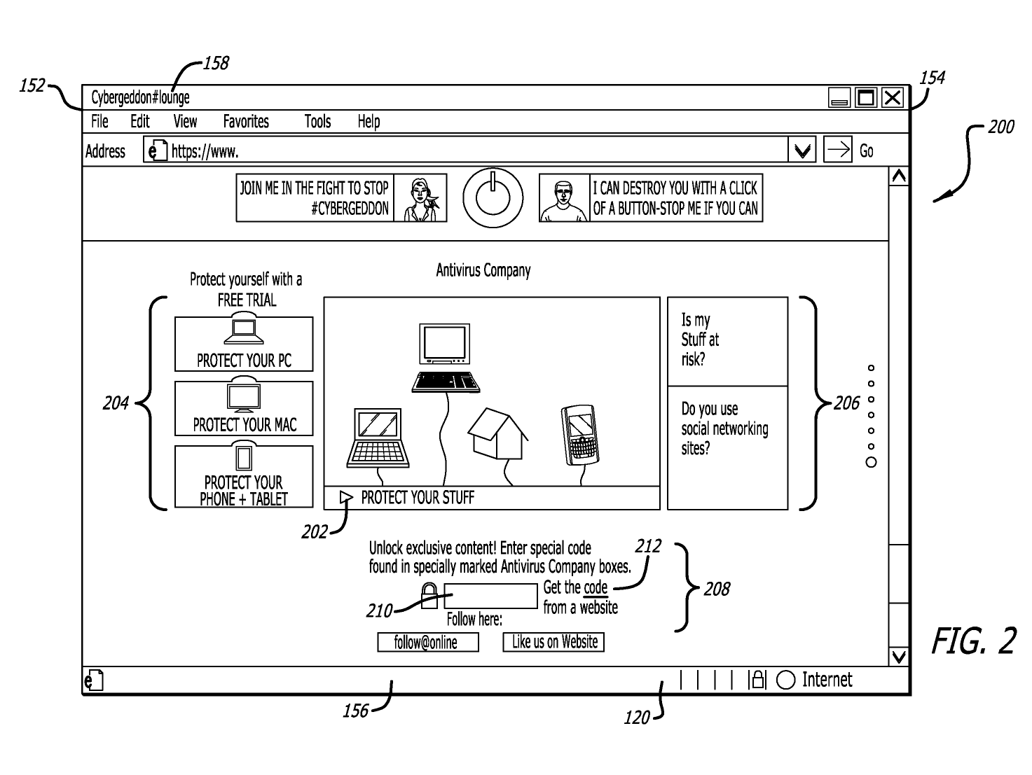

FIG. 2 is a schematic diagram showing a large canvas advertisement 200 that is designed to be included in the advertising portion 110 in accordance with embodiments described herein. It may be appreciated that the content description of the advertisement 200 is given herein only by the way of illustration and not limitation and that different kinds of advertisements can be designed to fit the advertising portion 110. The large canvas ad 200 is a full screen advertisement that is configured to form fit the display screen 120 of a device. The advertisement 200 extends lengthwise from one vertical edge 152 to an opposite vertical edge 154 of the screen 120 with a breadth extending from the top edge 158 to the bottom edge 156. The advertisement 200 comprises a media player 202 configured to play audio or video clips. It also includes various images 204, 206 advertising various products from the content sponsor. The advertisement also includes a gated content section 208 the provides interactivity to the users. In particular, the gated content section 208 includes a user entry box 210 for receiving code to unlock the auxiliary content available to customers who purchase specific products related to the advertiser. By the way of example, the code can be retrieved from specially marked boxes. In an embodiment, the gated content section can be unlocked through a social tie-in which in one implementation can include the user visiting the sponsor's FACEBOOK page to access the code to unlock exclusive content, for example, as indicated by the message 212. Other embodiments for providing code can be contemplated wherein the code is emailed or texted to a user who purchases products related to the advertiser.

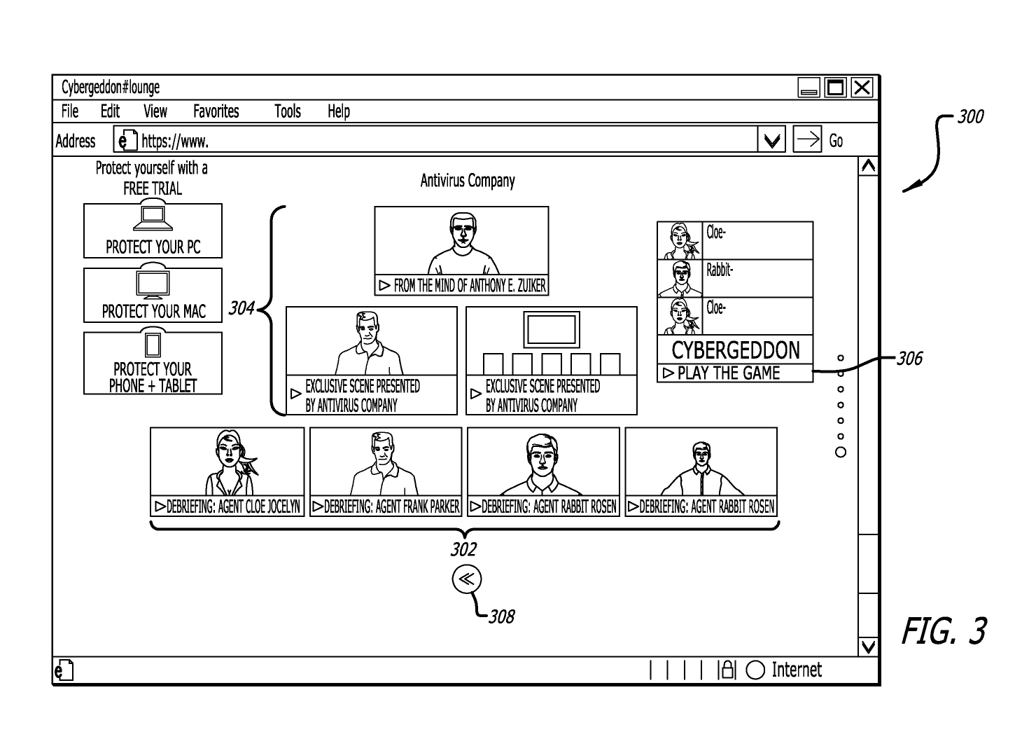

FIG. 3 is a schematic diagram 300 showing a large canvas ad with the auxiliary content that is displayed upon a user entering an unlock code in the box 210′ in accordance with embodiments described herein. The auxiliary content shown within the advertising portion 110 comprises video clips 302, 304 a video game 306 and images 204 that advertise and provide links to other webpages of the advertiser. A navigation element 308 is provided which, in this embodiment, facilitates a user to navigate back to the previous display shown in FIG. 2. In other embodiments the navigation element 308 can be configured to permit user navigation to other advertiser related displays or auxiliary content as described herein with respect to the navigation elements 114 shown in portion 104 in FIG. 1B.

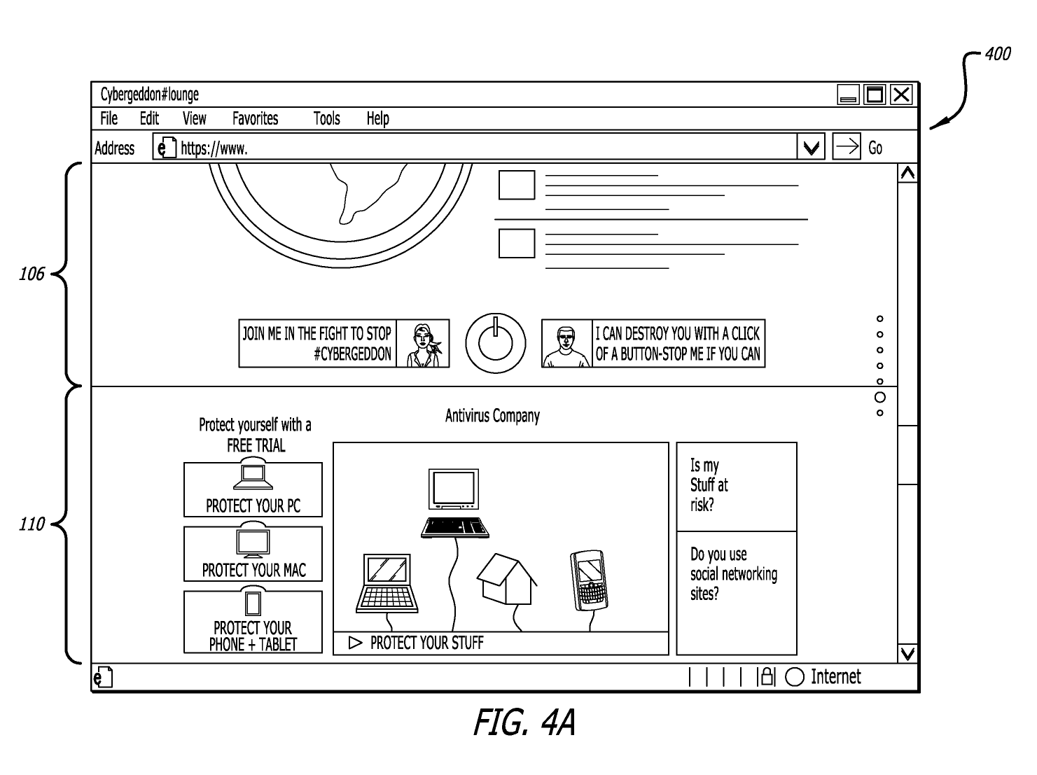

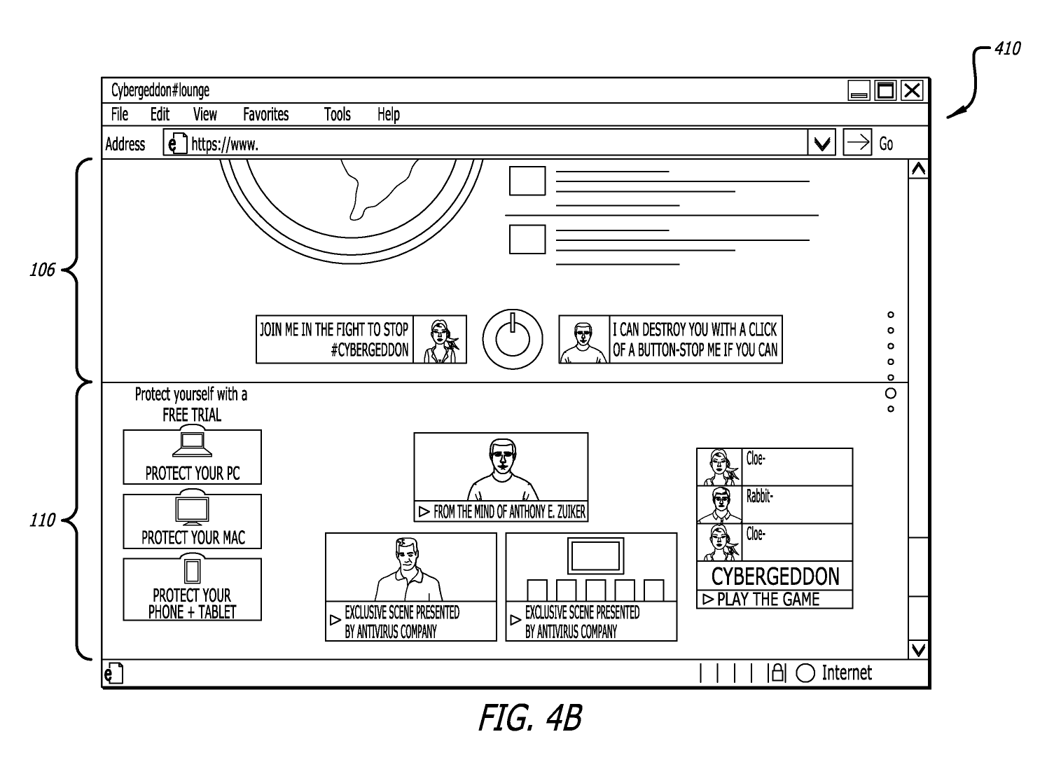

FIGS. 4A and 4B illustrate transitional schematic diagrams 400 and 410 respectively that show a user navigating from the advertising portion 110 of the webpage 100 to the social networking portion 106 by dragging the scrollbar 130. It may be noted that such user navigated does not particularly conform to the design of the webpage 100. In particular, FIG. 4A shows a display 400 wherein the user is navigating from the advertising portion 110 to the social networking portion 106 prior to entering the unlocking code in the gated content section 208. When FIG. 2 is compared with FIG. 4A, the flexibility of the large canvas ad to provide content to a user within a webpage while simultaneously permitting an advertiser to use an entire display screen for an advertisement can be appreciated. Similarly, by comparing FIG. 3 with FIG. 4B it may be further appreciated that while the display within the advertising portion 104 is changed upon a user entering the unlock code in the user entry box 210, the display in the remaining modules 102, 104 and 106 need not be altered, although it can be altered in other embodiments. For example, the content in the social networking portion 106 of the webpage 100 remains unchanged between FIG. 4A and 4B, while the display within the advertising portion 110 is updated to show the auxiliary content upon a user entering the unlocking code within the gated content section 208. The large canvas ads when slotted between other content modules or portions of a webpage 100 in accordance with embodiments described herein, provide a unique opportunity for the advertisers to better attract the attention of website visitors in non-intrusive manner.

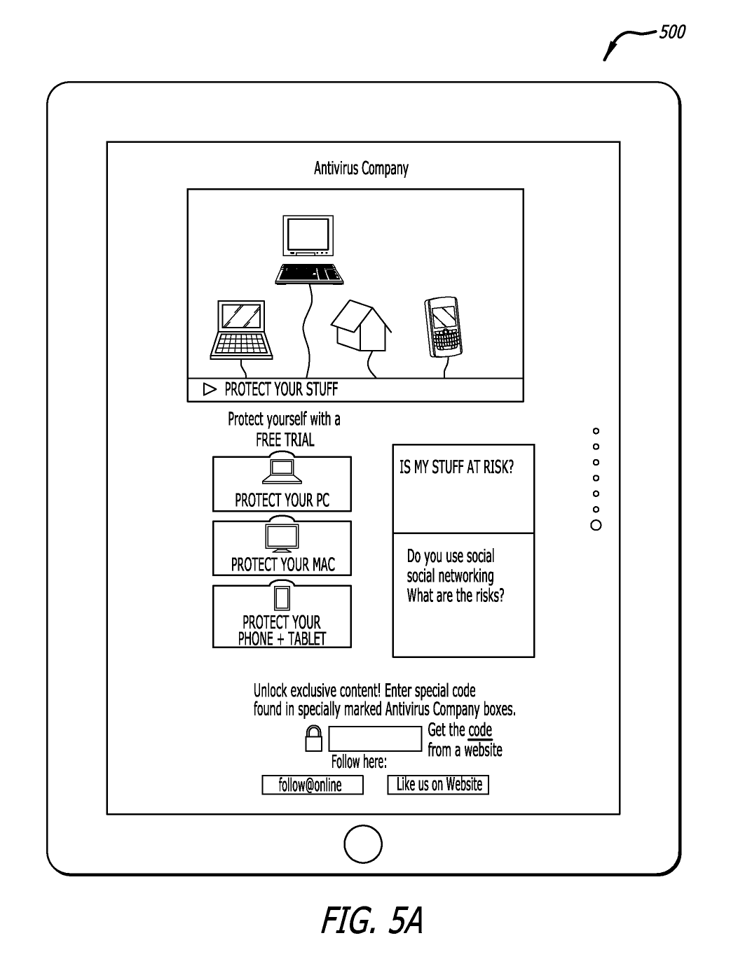

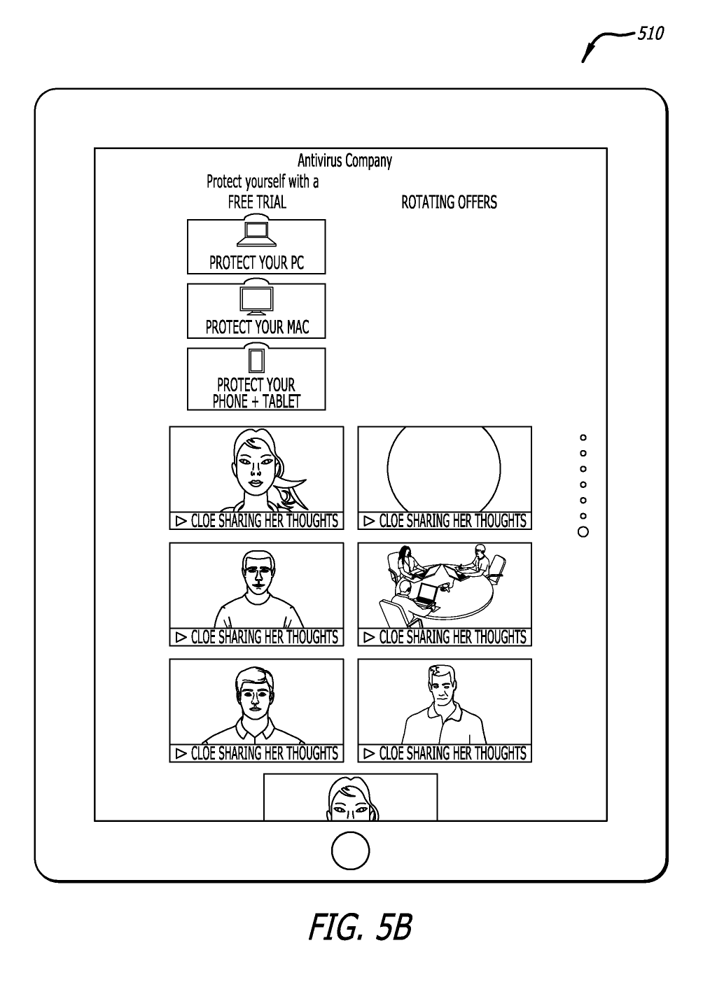

The figures discussed heretofore display the webpage 100 only in the landscape orientation. In accordance with further embodiments, the advertising portion 110 (or other portions 102, 104, 106 of the webpage) can be configured to be responsive to a change in orientation of the display screen 120. Thus, the advertising portion reshapes to form fit the display screen 120 upon a reorientation of a display screen 120 to a different position. FIG. 5A shows a schematic diagram 500 of content in the advertisement 200 rearranged automatically when the display screen 120 is changed from the landscape orientation as seen in FIG. 2 to a portrait mode. FIG. 5B is an illustration 510 that shows how the auxiliary content in the gated content section 208 re-orients or rearranges itself automatically when the orientation of the display screen 120 is changed from the landscape orientation as seen in FIG. 3 to a portrait orientation. The ad unit 200 is thus designed and built to shift and adapt to the screen resolution of an output device. The same module and code work seamlessly on desktop and on tablets in both portrait and landscape mode and helps reduce effort associated with developing ad units with a one size-fits all solution.

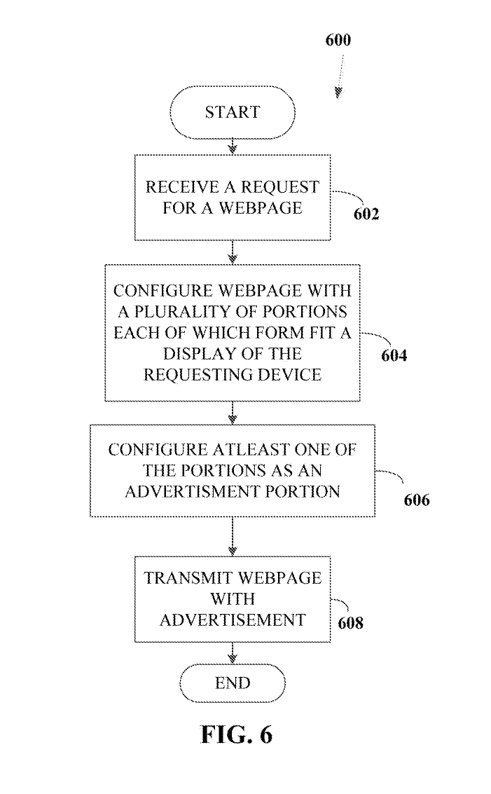

FIG. 6 shows a flowchart detailing a method of serving a full screen advertisement within a webpage of stacked modules in accordance with an embodiment. The method begins at 602 wherein a request for a webpage 100 is received. At 604, the requested webpage 100 is retrieved. The webpage 100 comprises a plurality of portions 102, 104, 106, 110 that form fit a display 120 of the requesting device. The requesting device can be any of a desktop, laptop, a tablet computer or a smartphone and the webpage can be configured to adapt to the output resolution of the device. More particularly, the display 120 of the device is delimited by a first set of opposite edges such as the left and right edges 152, 154 and a second set of opposite edges such as the top and the bottom edges 158, 156. Each of the plurality of portions 102, 104, 106, 110 of the webpage 100 is configured such that each portion extends between the first set of opposite edges and the second set of opposite edges to form fit the display 120. In an embodiment, the webpage 100 can include code to analyze the dimensions of a display on which it is to be shown and adjust the size of the portions accordingly. Therefore, the same code can be used across different display devices.

At least one of the portions 110 is configured as an advertising portion at 606 such that a full screen ad 200 can be presented in the advertising portion 110 In an embodiment, the full screen advertisement 200 can be configured such that it blends with or even further enhances the users' browsing experience. Such advertisements can be predetermined and included as part of the content in the webpage. In an embodiment, the full page advertisement 200 may have to be retrieved from an ad server. An “ad server” comprises a server that stores online advertisements for presentation to users. “Ad serving” refers to methods used to place online advertisements on websites, in applications, or other places where users are more likely to see them, such as during an online session or during computing platform use, for example. Therefore, the advertising section 110 can be configured to include a link to the ad server in this embodiment. In an embodiment, two or more of the portions 102, 104, 106, 110 can be configured as advertising portions wherein each portion is again configured to form fit the display 120 of a requesting device. The two portions may be arranged so that they are separated by at least one content portion of the webpage and may be configured to include the advertisement or links to advertising server or combinations thereof in accordance with the different embodiments. The full screen ad 200 as detailed herein provides a large space to the advertiser or sponsor to deliver their message without interrupting the users' browsing experience. At 608 the webpage with at least one full page advertisement or a link to the ad sever in the advertising section is transmitted for display at a requesting device.

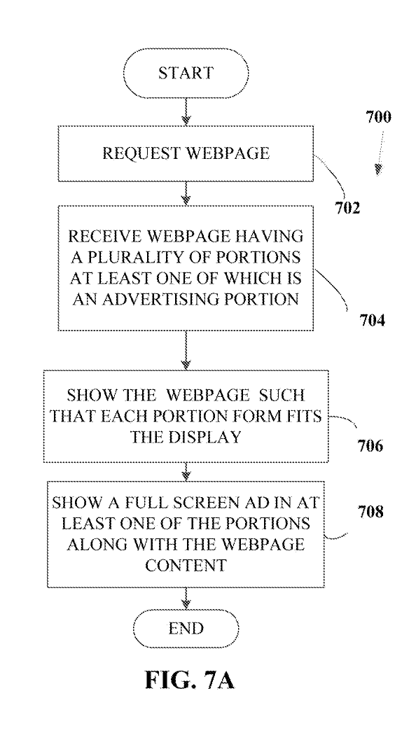

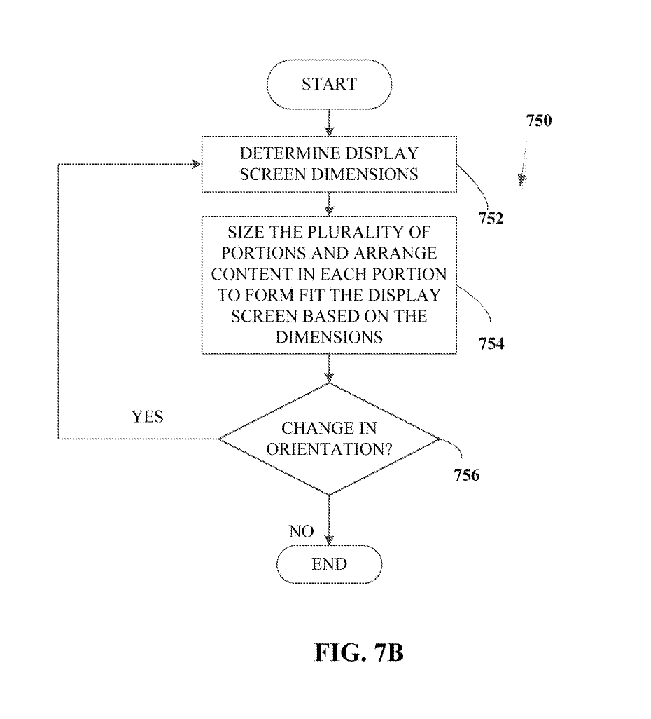

FIG. 7A shows a flowchart 700 detailing a method of displaying a full screen advertisement 200 without interrupting user browsing in accordance with an embodiment. The method begins at 702 wherein a request for a webpage 100 is transmitted and the webpage 100 is received at 704. The webpage 100 is configured to include a plurality of portions 102, 104, 106, 110 wherein each portion form fits a display 120 on which the webpage 110 is to be shown. In an embodiment, the code module associated with the webpage 110 is configured to obtain the dimensions of the screen 120 on which the webpage is to be displayed and adjusts each portion 102, 104, 106, 110 to form fit the display 120. Therefore, the webpage 100 is shown at 706 so that each of the plurality of portions 102, 104, 106, 110 form fit the display or content in each of the portions 102, 104, 106, 110 is sized and arranged to be displayed within the four edges that delimit the display 120. At 708 a full screen advertisement 200 is included within at least one of the portions so that an advertiser or a content sponsor can deliver their message while the users' browse the original webpage. The advertisement 200 can be part of the webpage 100 and can be served along with the content or it can be retrieved via a link from a disparate ad server.

FIG. 7B shows a flowchart detailing a method of configuring modules or portions of a webpage 100 flexibly to form-fit a display screen 120 in accordance with an embodiment. The method begins with the determination of the dimensions of a display screen at 752. Code associated with a transmitted webpage 100 can be executed by a device that receives the webpage 100 in order to determine the dimensions of the display 120 connected to the device. Based on the dimensions of the display screen, each of the plurality of portions or modules 102, 104, 106, 110 of a transmitted webpage can be sized and content therein can be arranged at 754 in order to form-fit the display screen as shown and described herein for example at FIGS. 2, 3, 5A and 5B. In addition, code can also be associated with the webpage can to determine if the orientation of the device displaying the webpage 100 has changed. For example, for mobile devices like smartphones or tablet computers, their orientation (and hence the display screen orientation) can be changed from landscape to portrait and vice versa which can cause a change in the dimensions of the display screens which are usually rectangular. Hence, if it is determined at 756 that there is a change in the orientation of the device displaying the webpage 100, the process of configuring modules/portions 102, 104, 106, 110 to form-fit the display screen again determines the dimensions of the display screen at 752 and hence re-sizes and/or re-arranges the content therein to form-fit the changed dimensions. By the way of illustration and not limitation changes to content arrangement can include for example, images or links arranged horizontally in a landscape orientation may be re-arranged vertically to fit the new portrait orientation or if the resolution of the display screen is changed, image quality may be adjusted to the changed resolution. If the orientation is stable and does not change the process terminates on the end block. As the code to determine the display dimensions and content arrangement etc. is executed at the device receiving the webpage, the same code can be used across different platforms for different types/sizes of display screens.

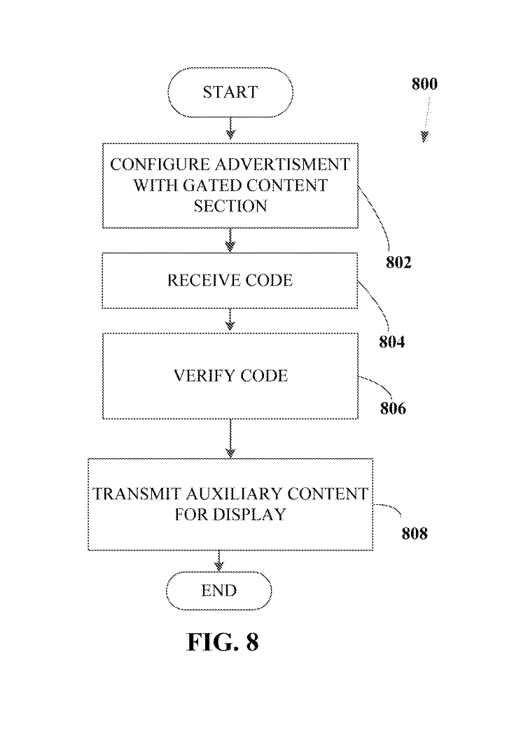

FIG. 8 shows a flowchart 800 detailing a method of encouraging positive user interaction with an advertisement in accordance with an embodiment. The various forms of advertisement such as interstitials or takeovers prevent users from proceeding further with their browsing without first interacting with the advertisement. User interactions with such ads usually involve the user closing the ad in order to proceed with browsing the webpage. As discussed supra, the large canvas ad 200 permits a user to browse a webpage 100 even while it occupies the full screen when displayed in its entirety. In an embodiment, positive user interaction other than the user skipping the ad can be encouraged by including a gated content section 208 in the advertisement 200 as shown at 802. A gated content section 208 can be a part of the full screen ad 200 wherein a user needs to interact with the advertisement 200 in order to obtain access to additional content which may be cumulative to or enhance the content currently displayed in a webpage. In an embodiment, the gated content section 208 can be configured with an input element to receive user input such as, a code to unlock the additional content. The code that is entered by a user is received as shown at 804. In different embodiments, the code can be received by a content server or an advertisement server. The received code is verified at 806 and additional content is transmitted for display at 808. In an embodiment, the additional content can configured for presentation in a media player which is also comprised within the advertisement portion or as an overlay on the webpage in order to continue the user engagement with the advertisement.

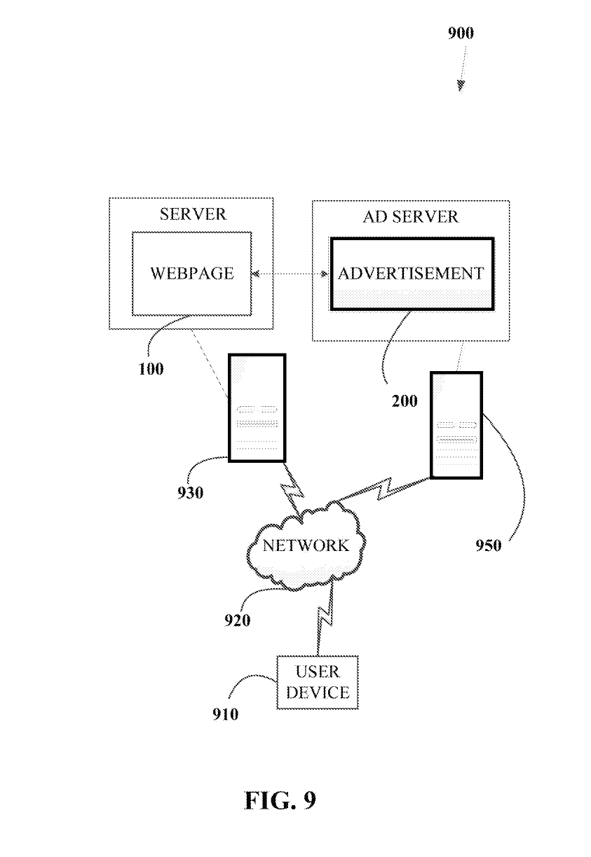

FIG. 9 illustrates a schematic diagram of a system 900 for generating and displaying a multi-device website 100 in accordance with embodiments described herein. The system 900 includes a client device 910 employed by a user for accessing the webpage 100. The client device 910 transmits a request for a webpage 100 via a network 920, such as one or more of the Internet or a cellular network, to a server 930. It may be appreciated that only one client device 910 is shown for illustrative purposes and that any number of devices can be accessing a webpage and hence can transmit requests for a webpage 100. The server 930 that hosts the webpage 100 receives the request and transmits the webpage 100 for display at the user device 910. The server 930 can also transmit accompanying code along with the webpage 100 that facilitates form fitting different portions 102, 104, 106, 110 of the webpage 100 to a display 120 of the user device 910. The code when executed by a processor at the user device 910 is configured to obtain dimensions of the display 120 and adjust the portions 102, 104, 106, 110 to form fit the display. In an embodiment, the server 930 can also include an advertisement 200 within the webpage 100. The advertisement 200 can be part of the content served with the webpage 100 or it can be retrieved from a disparate ad server 950 connected to the host server 930, via the network 920.

In an embodiment, the webpage 100 is configured with a code module that can estimate the dimensions of a display screen on the user device 910 and adjust the size of the portions in the webpage 100 so that each of the portions form fits the display screen. The user device 910 receives the webpage 100, executes the code associated therewith in order to display the webpage 100 and the advertisement 200 in conformance with the code associated therewith.

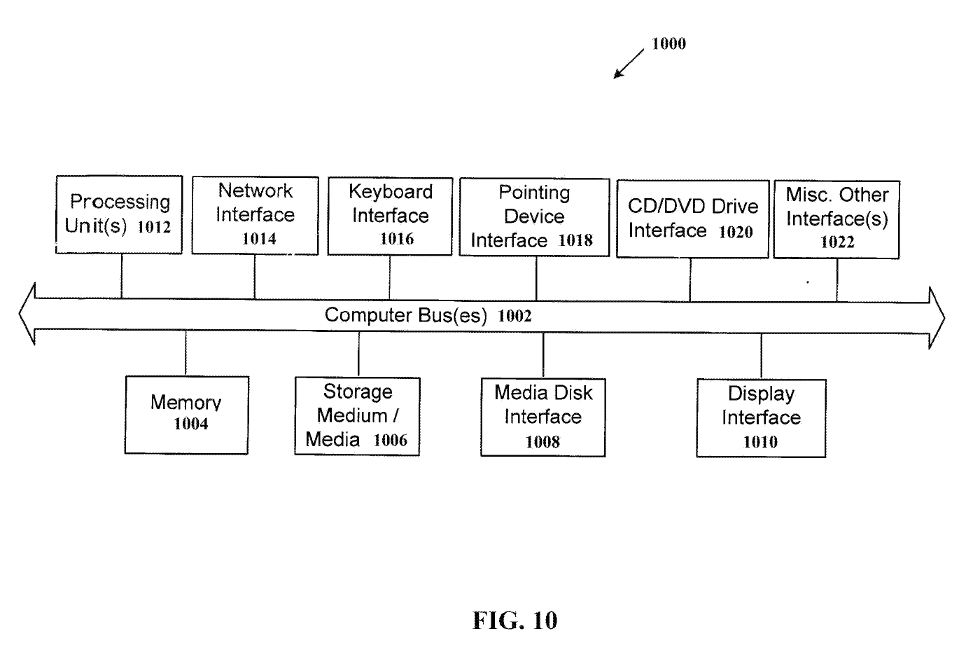

As shown in the example of FIG. 10, internal architecture of a computing device 1000 includes one or more processing units (also referred to herein as CPUs) 1012, which interface with at least one computer bus 1002. Also interfacing with computer bus 1002 are persistent storage medium/media 1006, network interface 1014, memory 1004, e.g., random access memory (RAM), run-time transient memory, read only memory (ROM), etc., media disk drive interface 1008, an interface 1020 for a drive that can read and/or write to media including removable media such as floppy, CD-ROM, DVD, etc., media, display interface 1010 as interface for a monitor or other display device, keyboard interface 1016 as interface for a keyboard, pointing device interface 1018 as an interface for a mouse or other pointing device, and miscellaneous other interfaces 1022 not shown individually, such as parallel and serial port interfaces, a universal serial bus (USB) interface, and the like.

Memory 1004 interfaces with computer bus 1002 so as to provide information stored in memory 1004 to CPU 1012 during execution of software programs such as an operating system, application programs, device drivers, and software modules that comprise program code or logic, and/or computer-executable process steps, incorporating functionality described herein, e.g., one or more of process flows described herein. CPU 1012 first loads computer-executable process steps or logic from storage, e.g., memory 1004, storage medium/media 1006, removable media drive, and/or other storage device. CPU 1012 can then execute the stored process steps in order to execute the loaded computer-executable process steps. Stored data, e.g., data stored by a storage device, can be accessed by CPU 1012 during the execution of computer-executable process steps.

Persistent storage medium/media 1006 is a computer readable storage medium(s) that can be used to store software and data, e.g., an operating system and one or more application programs. Persistent storage medium/media 1006 can also be used to store device drivers, such as one or more of a digital camera driver, monitor driver, printer driver, scanner driver, or other device drivers, web pages, content files, metadata, playlists and other files. Persistent storage medium/media 1006 can further include program modules and data files used to implement one or more embodiments of the present disclosure.

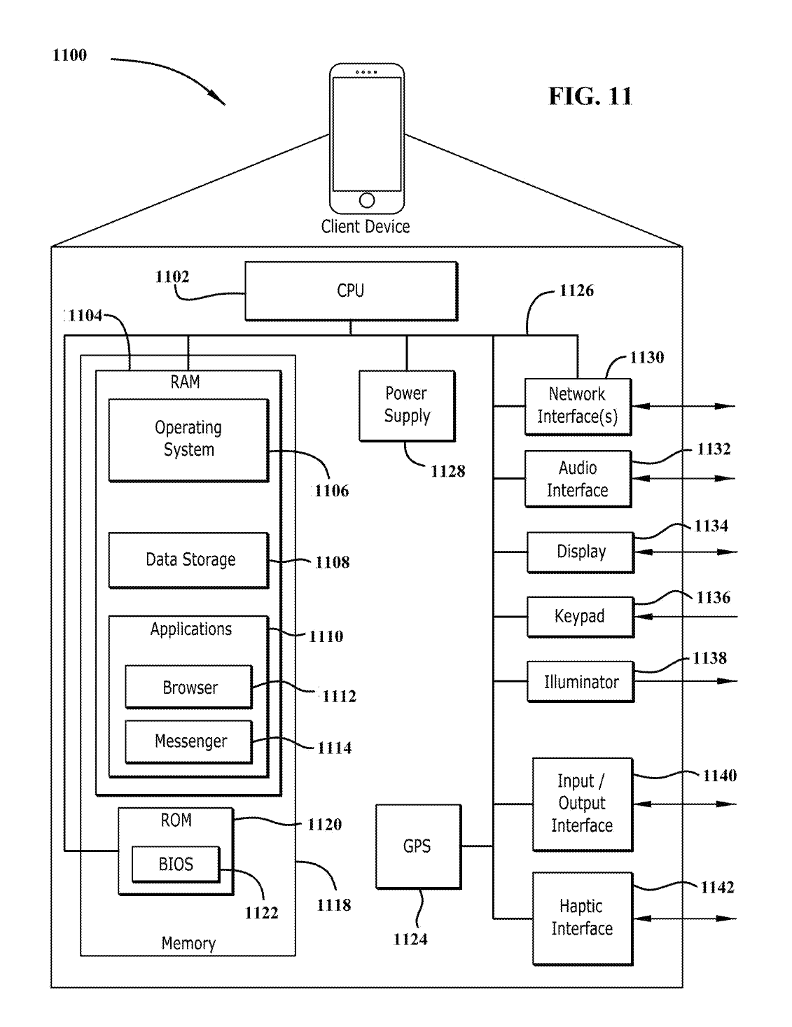

FIG. 11 is a schematic diagram illustrating a client device implementation of a computing device in accordance with embodiments of the present disclosure. A client device 1100 may include a computing device capable of sending or receiving signals, such as via a wired or a wireless network, and capable of running application software or “apps”. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 1102, power supply 1128, a memory 1118, ROM 1120, BIOS 1122, network interface(s) 1130, audio interface 1132, display 1134, keypad 1136, illuminator 1138, I/O interface 1140 interconnected via circuitry 1126. Claimed subject matter is intended to cover a wide range of potential variations. For example, the keypad 1136 of a cell phone may include a numeric keypad or a display 1134 of limited functionality, such as a monochrome liquid crystal display (LCD) for displaying text. In contrast, however, as another example, a web-enabled client device 1100 may include one or more physical or virtual keyboards 1136, mass storage, one or more accelerometers, one or more gyroscopes, global positioning system (GPS) 1124 or other location identifying type capability, Haptic interface 1142, or a display with a high degree of functionality, such as a touch-sensitive color 2D or 3D display, for example. The memory 1118 can include Random Access Memory 1104 including an area for data storage 1108.

A client device 1100 may include or may execute a variety of operating systems 1106, including a personal computer operating system, such as a Windows, iOS or Linux, or a mobile operating system, such as iOS, Android, or Windows Mobile, or the like. A client device 1100 may include or may execute a variety of possible applications 1110, such as a client software application 1114 enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A client device 1100 may also include or execute an application to communicate content, such as, for example, textual content, multimedia content, or the like. A client device 1100 may also include or execute an application 1112 to perform a variety of possible tasks, such as browsing, searching, playing various forms of content, including locally stored or streamed content, such as, video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving, by a processor, a request for a webpage from a device comprising a display screen;
retrieving, by the processor, the webpage partitioned horizontally into a plurality of portions arranged one below another, each portion of the plurality of portions is configured to form fit the display screen;
configuring, by the processor, at least one of the plurality of portions as an advertising portion such that an advertisement within the advertising portion form fits the display screen; and
transmitting, by the processor, the webpage comprising the advertising portion to the device.

2. The method of claim 1, wherein each of the plurality of portions is configured to form-fit the display screen such that each portion extends between a first set of opposite edges and a second set of opposite edges that delimit the display screen.

3. The method of claim 2, wherein configuring each of the portions further comprises:
transmitting with the webpage, by the processor, code that determines dimensions of the display screen; and
transmitting with the webpage, by the processor, code to size each of the plurality of portions and arrange content therein based on the determined dimensions.

4. The method of claim 1, further comprising:
including, by the processor, within the advertising portion a link to an advertising server.

5. The method of claim 1, further comprising:
including, by the processor, a gated content section within the advertising portion, the gated content section that facilitates providing additional content in the advertisement.

6. The method of claim 5, further comprising: receiving, by the processor, a code for unlocking the additional content in the gated content section;
verifying, by the processor, the code; and
transmitting, by the processor, the additional content upon the verification.

7. The method of claim 6, further comprising:
configuring, by the processor, the gated content section for prompting a user to visit a second webpage disparate from the webpage to obtain the code.

8. The method of claim 1, further comprising:
configuring, by the processor, the webpage such that each of the plurality of portions form fit the display screen upon a reorientation of the device from an original position to a new position.

9. The method of claim 8, further comprising:
transmitting with the webpage, by the processor, code that detects orientation of the device and code that determines dimensions of the display screen when a change in orientation is detected.

10. The method of claim 8, further comprising:
configuring, by the processor, the plurality of portions, such that content in one of the plurality of portions that is displayed is rearranged upon the reorientation of the device to the new position.

11. The method of claim 1, wherein the at least two of the plurality of portions are configured as advertising portions and the method further comprises:
configuring, by the processor, the webpage such that at least one content bearing portion of the plurality of portions is inserted between the two advertising portions.

12. The method of claim 11, further comprising:
inserting, by the processor, two links to two different advertisements in the two portions.

13. A computer readable storage medium, comprising instructions, which when executed by a processor cause the processor to:
receive a request for a webpage from a device comprising a display;
retrieve the webpage partitioned horizontally into a plurality of portions arranged one below another, each portion of the plurality of portions is configured to form-fit the display;
configure at least one of the plurality of portions as an advertising portion such that an advertisement within the advertising portion form fits the display; and
transmit the webpage comprising the advertising portion to the device.

14. The computer readable storage medium of claim 13, wherein each of the plurality of portions is configured to form-fit the display such that each portion extends between a first set of opposite edges and a second set of opposite edges that delimit the display.

15. The computer readable storage medium of 14, wherein instructions for configuring each of the portions further comprise instructions for:
transmitting with the webpage, code that determines dimensions of the display; and
transmitting with the webpage, code to size each of the plurality of portions and arrange content therein based on the determined dimensions.

16. The computer readable storage medium of claim 13, further comprising instructions for:
including within the advertising portion a link to an advertisement from an advertising server.

17. The computer readable storage medium of claim 13, further comprising instructions for:
including, by the processor, a gated content section within the advertising portion, the gated content section facilitates providing additional content within the advertisement.

18. A computing device comprising:
a processor;
a storage medium for tangibly storing thereon program logic for execution by the processor, the program logic comprising:
request receiving logic, executed by the processor, for receiving a request for a webpage from a device comprising a display;
webpage retrieval logic, executed by the processor, for retrieving the webpage partitioned horizontally into a plurality of portions arranged one below another, each portion of the plurality of portions is configured to form-fit the display;
configuring logic, executed by the processor, for configuring at least one of the plurality of portions as an advertising portion such that an advertisement within the advertising portion form fits the display; and
transmitting logic, executed by the processor, for transmitting the webpage comprising the advertising portion to the device.

19. The device of claim 18, wherein each of the plurality of portions is configured to form-fit the display screen such that each portion extends between a first set of opposite edges and a second set of opposite edges that delimit the display screen.

20. The device of claim 19, wherein the advertisement comprises a gated content section that provides additional content.

21. The device of claim 20, wherein the additional content is bonus content associated with content of the webpage.
